(19) United States
(12) Patent Application Publication
(10) Pub. No.: US 2010/0192066 A1
(43) Pub. Date: Jul. 29, 2010

(54) METHOD AND SYSTEM FOR A GRAPHICAL USER INTERFACE

(76) Inventor: Lushen Wu, Cambridge, MA (US)

Correspondence Address: LANDO & ANASTASI, LLP, ONE MAIN STREET, SUITE 1100, CAMBRIDGE, MA, 02142, US

(21) Appl. No.: 12/360,672

(22) Filed: Jan. 27, 2009

(51) Int. Cl. G06F 3/048

(52) U.S. Cl. 715/727; 715/781

(57) ABSTRACT

A method of providing capabilities for searching a plurality of audio files by a graphical user interface in a display. A window showing information concerning at least one of a plurality of audio files is configured to operate in an always-on-top mode within the user interface, while occupying an area that is substantially less than 10% of the display's overall area. The window provides a search entry element configured to receive at least one search criterion provided by a user, the search criterion established by the user to identify at least one audio file from among the plurality of audio files. Additional unobtrusive windows are provided in the same user interface to present the results of search actions, these additional windows being initialized as hidden, and visible when a user initiates a search action or actively engages the search results.

### BACKGROUND OF INVENTION

1. Field of Invention

Embodiments of the invention relate generally to accessing data via a graphical user interface. More specifically, at least one embodiment relates to a method and a system for providing full search capabilities via a small form factor always-on-top window in a graphical user interface.

2. Discussion of Related Art

Graphical user interfaces are ubiquitous today for managing/accessing applications in a computer system. In general, the graphical user interfaces provide text-based and/or control-based access to the functionality and information available in one or more applications. For example, current media systems allow users to purchase, share and listen to files included in an audio collection stored in local memory or accessed over the Internet.

As one example, a window having a small footprint and being represented in an always-on-top mode is one manner in which current systems provide a user some limited access and/or information concerning an application. In general, however, the functionality provided by these small display windows is very limited and a user must open additional windows or switch to windows occupying a much greater percentage of the area provided in a graphical user interface to effectively locate and manage files associated with the application.

Further, information and functionality available via the application (for example, metadata associated with the application-files) is displayed in a manner that requires either constant user interaction or abbreviated presentation because the display regions for the information are insufficient to fully display the information and/or functionality. For example, where the window is insufficient to display an entire item because the item is too long, items are truncated in a manner which makes it difficult to fully identify an item or distinguish between items. That is, the items lose the full value of their information and some of their identifying characteristics when viewed in the window. As another example, prior systems may expand the field size, for example, via a tooltip, when an item is engaged by the user. In another prior approach, a user is required to manually move the border of the field to expand the field to see more than the abbreviated portion that is typically displayed. In both preceding approaches, the expanded field size results in other regions of the display being reduced in size or at least temporarily obscured from view.

Some applications also have additional drawbacks concerning the manner in which collections of data are presented graphically to a user. For example, these icon or image based presentations often use a tile format to display the items. However, when a member of a collection is selected the details concerning that collection are presented in additional panes that obscure other members of the collection in the current view. The display of the additional panes in the foreground also requires that a user manually open, close, or otherwise back-track from successive panes to move through the various levels of detail concerning the collection. These extra user activities detract from the user's experience and do not provide an intuitively obvious and seamless presentation of the information concerning the collection and the items in it.

Accordingly, it would be advantageous to overcome these and other shortcomings of the current approaches.

### SUMMARY OF INVENTION

Embodiments of the present invention provide systems and methods that allow a user to locate, manage, and review information and the source of the information, for example the contents of a collection of files, for example, media files, in an intuitive and efficient way. In general, some embodiments provide this functionality via a window in a graphical user interface which occupies substantially less than all of the full area of a graphical user interface rendered in a display. Further, some embodiments provide the window in an always-on-top mode. This small form factor window can provide a user with full search capabilities and quickly and unobtrusively present large bodies of search results for easy access by the user. For example, the search results may be overlaid over the user's other active windows, and hidden when search functions are no longer actively engaged.

Some embodiments provide the user with an ability to locate further details concerning a search result while also allowing the user to review items not included in the search results but related to a particular search result in a manner other than the search criterion. Some embodiments provide systems and methods that have broad utility and can be applied wherever data is accessed electronically using a graphical user interface. Further, the preceding can be achieved without occupying substantial “real estate” in the graphical user interface while also reducing the user actions (and/or the complexity of those user actions) required to access the additional information.

According to one aspect, the invention provides a method of providing search capabilities for searching a plurality of audio files via a graphical user interface presented in a display. In accordance with one embodiment, the method includes acts of presenting, in the graphical user interface, a window to provide information concerning at least one of the plurality of audio files; configuring the window to operate in an always-on-top mode within the display, and while in the always-on-top mode, the window occupying an area that is substantially less than 100% of an overall area provided by the display; providing a search entry element in the window when the window is configured in the always-on-top mode, wherein the search entry element is configured to receive at least one search criterion provided by a user, the search criterion established by the user to identify at least one audio file from among the plurality of audio files; and providing at least one additional interface in the graphical user interface, the at least one additional interface configured to present at least one of search results and information having an association with a search result included in the search results. According to some embodiments, the at least one additional interface is configured to be initialized as hidden and then displayed when the user performs at least one of initiating a search and actively engaging either of the search results and the information having the association with the search result.

In accordance with another aspect, the invention provides a method of providing search capabilities in a graphical user interface employed with a computing device. In accordance with one embodiment, the method includes acts of presenting, in the graphical user interface, a window configured in an always-on-top mode, the window occupying an area that is substantially less than 5% of an overall area provided by the graphical user interface; and providing a search entry element in the window when the window is configured in the always-on-top mode and without changing the area occupied by the window. According to some embodiments, the search entry element is configured to receive at least one search criterion provided by a user, the search criterion established by the user to identify at least one record from among a plurality of records associated with an application.

In accordance with yet another aspect, the invention provides a method of displaying a record in a graphical user interface rendered in a display. According to one embodiment, the method includes acts of providing a display region having a region length, the display region configured to display at least one field of a record, the record having a full length greater than the region length; configuring the record such that successive fields in the record are initialized horizontally adjacent to each other; configuring the display region such that the at least one field is only visible in the display region for portions of the at least one field which overlap the display region; and configuring the graphical user interface to allow all portions of the record to be viewed within the display region by movement of the record relative to the display region.

In accordance with still another aspect, a computer-readable medium is encoded with instructions for execution on a computer system. According to some embodiments, the instructions when executed, perform a method of presenting, in a graphical user interface, a window to provide information concerning at least one of a plurality of audio files; configuring the window to operate in an always-on-top mode within the display, and while in the always-on-top mode, the window occupying an area that is substantially less than 100% of an overall area provided by the display; providing a search entry element in the window when the window is configured in the always-on-top mode, where the search entry element is configured to receive at least one search criterion provided by a user, the search criterion established by the user to identify at least one audio file from among the plurality of audio files; and providing at least one additional interface in the graphical user interface, the at least one additional interface configured to present at least one of search results and information having an association with a search result included in the search results, where the at least one additional interface is configured to be initialized as hidden and then displayed when the user performs at least one of initiating a search and actively engaging either of the search results and the information having the association with the search result.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a graphical user interface in accordance with one embodiment of the invention.

FIG. 2 illustrates a further embodiment of a graphical user interface of FIG. 1.

FIG. 3 illustrates further information provided in a graphical user interface in accordance with one embodiment.

FIG. 4 provides yet another embodiment where further information is provided in a graphical user interface.

FIG. 5 is still a further embodiment where additional information is provided in a graphical user interface.

FIG. 6 illustrates a scrolling feature in accordance with one embodiment.

FIG. 7 illustrates an embodiment of the scrolling function as applied in a media application in a graphical user interface.

FIG. 8 illustrates a further scrolling feature provided in a graphical user interface in accordance with one embodiment.

FIG. 9 further illustrates the embodiment of FIG. 8.

FIG. 10 illustrates a rendering of a collection of data in accordance with one embodiment.

FIG. 11 illustrates the rendering of information concerning the collection in FIG. 10 in accordance with one embodiment.

FIG. 12 illustrates the rendering of information concerning the collection in FIG. 10 in accordance with a further embodiment.

### DETAILED DESCRIPTION

This invention is not limited in its application to the details of construction and the arrangement of components set forth in the following description or illustrated in the drawings. The invention is capable of other embodiments and of being practiced or carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

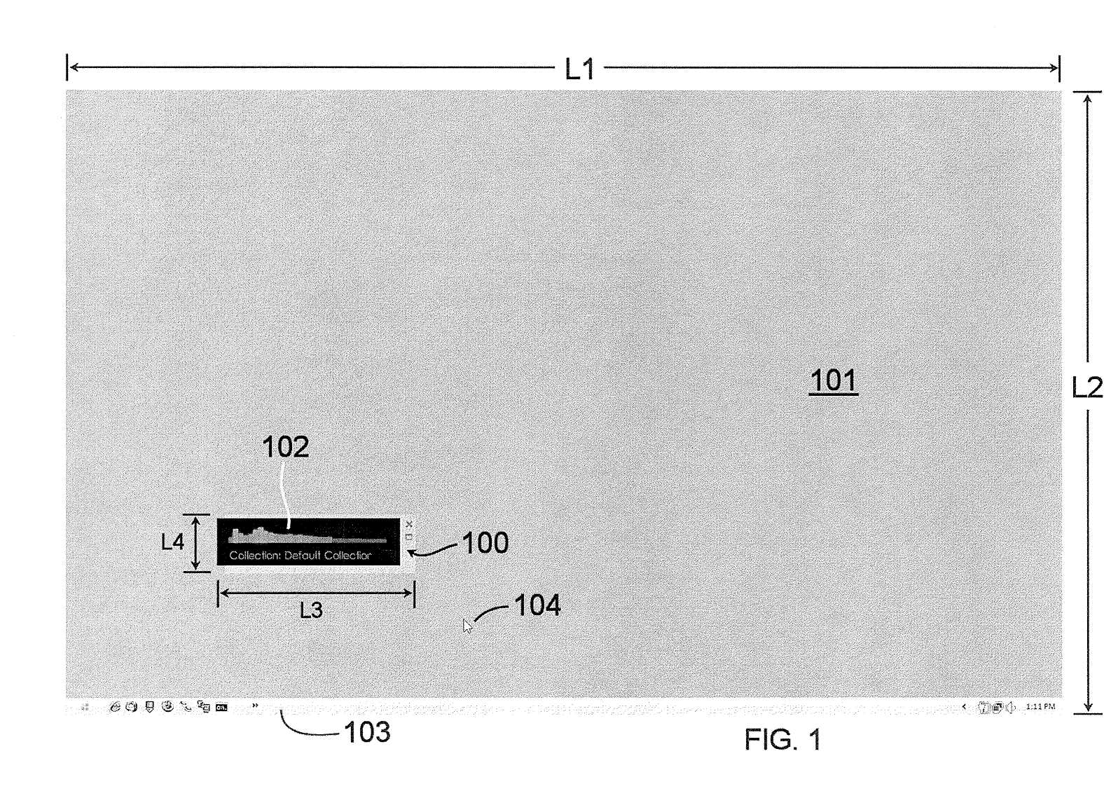

FIG. 1 illustrates a graphical user interface (“GUI”) 101. In the illustrated embodiment, the GUI 101 is sized with dimensions L1 and L2 which results in the GUI providing an area of L1×L2 for display. In general, the GUI 101 is rendered in a display of a computing device. As used herein, the term “computing device” refers to any device that stores and processes programs. For example, each of a desktop computer, notebook computer, laptop computer, personal digital assistant (PDA), cell phone, video game console and the like can be computing devices. In some embodiments, the display in which the GUI is rendered is an integral part of the computing device. In an alternate embodiment, the display is a separate piece of hardware that is in communication with the processor of the computing device. Often, the GUI 101 occupies the full display of the computing device. Where the GUI occupies the full display, the dimensions L1 and L2 correspond to the height and the width of the display, respectively.

In the illustrated embodiment, the GUI 101 includes a task bar 103 which is located adjacent a portion of the GUI which displays one or more windows of active applications operating on the computing device. The GUI 101 may also include a cursor 104 or other device that allows a user to select items rendered in the GUI 101. For example, the user can select a window in which to work. The current window in which the user is actively working is generally placed above other open windows and may be referred to as the window on which the user is focused or the ‘active’ window.

In the illustrated embodiment, a window 100 is rendered in the GUI 101. The window occupies an area of the GUI defined by the dimensions L3 and L4 such that the total area occupied by the window 100 equals L3×L4. FIG. 1 illustrates the window 100 in an “unfocused” state, that is, the user is not taking any current action in the window 100. According to one embodiment, the user activates the window and places it in a “focused state” by locating the cursor 104 over the window 100 (i.e., by “hovering” the cursor over the window 100), or by thereafter clicking within the bounds of the window 100.

In some embodiments, the window 100 is presented as an always-on-top window, that is, the window is always presented on top of other applications which are open in the GUI. Further, to minimize an impact of the window 100 (while maintaining its presence for the user) the window 100 is sized to occupy substantially less than all of the area of the GUI and/or the display in which the GUI is rendered. In various embodiments, the small form factor always-on-top representation allows the user to maintain visibility of one application and then quickly and easily access substantial functionality of a second application via the window 100.

In accordance with one embodiment, the window 100 is associated with a media application such as a media player for audio files and includes a visualizer element 102 concerning a track that is currently being played by the computing device, for example, a histogram to show the frequency distribution of the sound being generated by the current audio track. According to further embodiments, the window 100 may display different information concerning the track such as an oscilloscope plot to view the wave shape being generated by the current track. In addition, the window 100 can include a text display which can be used to display metadata concerning the current track such as the title, artist, album, etc. According to another embodiment, the user can customize the information which is displayed in the window 100 including the contents and/or subject of visualizer element 102 and the text displays which are available. Further, as is well known by those of ordinary skill in the art, the window 100 can include control elements to switch the window to a less compact layout mode, or to close the window 100.

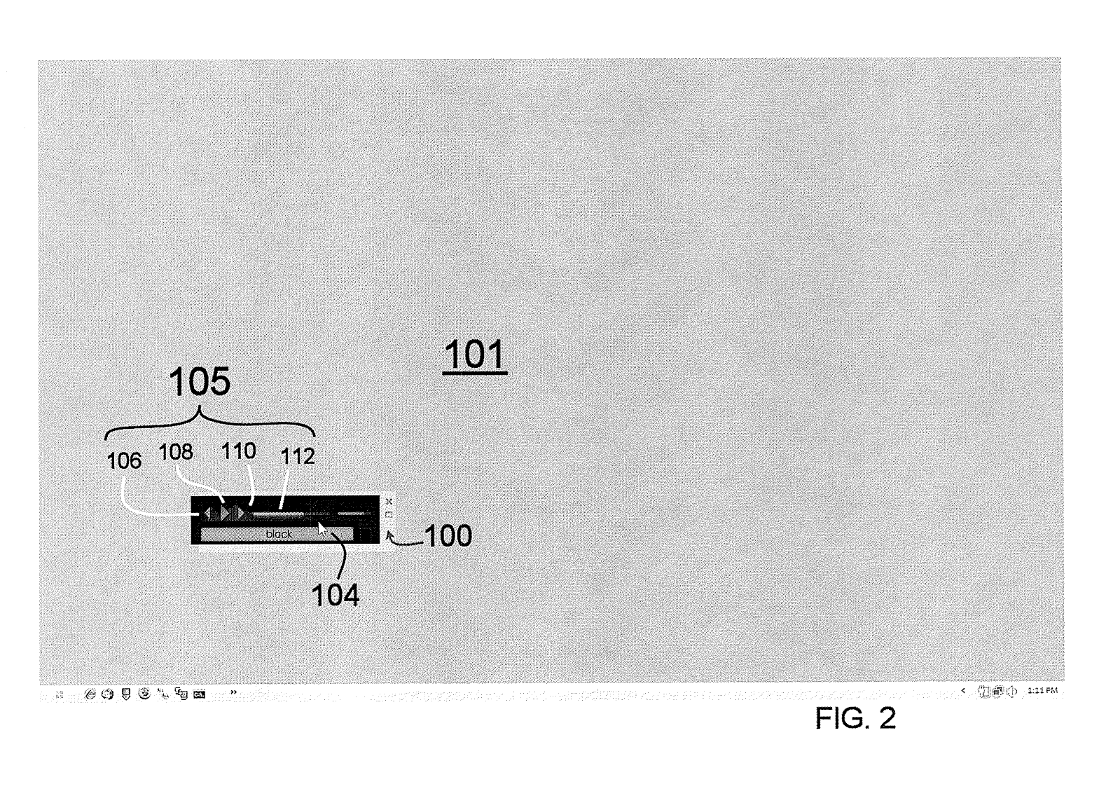

In accordance with one embodiment, the window 100 provides the user with an interface to an application and the data accessible in the application. In further embodiments, the window allows the user access to both a great breadth and a great depth of information concerning the application and does so with a relatively low level of effort and complexity of effort required of the user. As illustrated in FIG. 2, the user can employ the cursor 104 to activate the window to access the substantial functionality available via the window 100. In accordance with other embodiments, means of activation other than a cursor are employed to activate the window. For example, in one embodiment, a particular sequence of keys selected by the user can activate the window 100 while in another embodiment, an external selection means is employed with the GUI 101.

In the embodiment shown in FIG. 2, a plurality of control elements 105 are provided to allow the user to control the playback of an audio file. In one embodiment, the control elements include a rewind element 106, a pause element 108, a fast forward element 110, and a progress bar 112. Other playback control elements and control elements of other types may also be made available when the user “hovers” a cursor 104 over the window 100 depending on the functionality that is desired. According to one embodiment, the activation of the window 100 causes a sharp reduction in the opacity of the visualizer element 102 and the control elements 105 are rendered in the region occupied by the visualizer element 102, directly overlaid on the visualizer element 102.

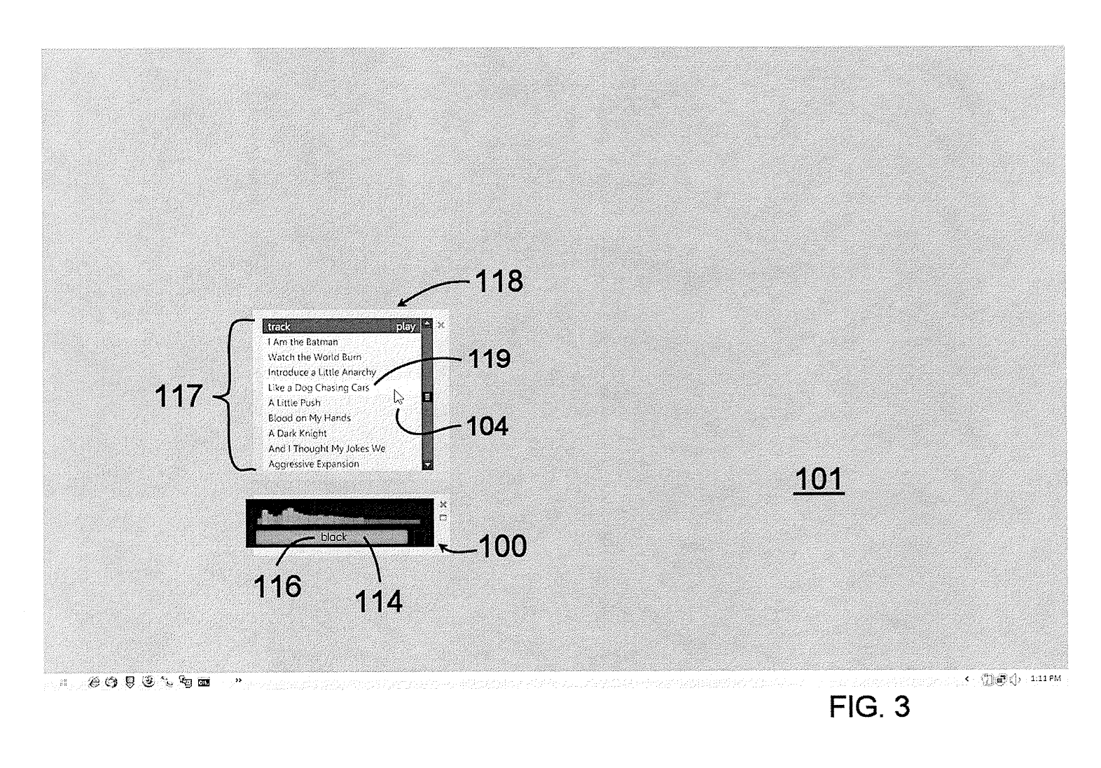

Referring to FIG. 3, in a further embodiment, the window 100 includes a region 114 that provides a user a location to input search criterion 116, i.e., a search query that can be used to search for relevant information accessed by the window's 100 related application or applications. According to one embodiment, the region 114 is hidden from view until a predetermined (for example, user selected) set of keystrokes causes the region 114 to be presented in the window 100. In yet another embodiment, the region 114 is automatically presented when the user engages the window 100 by for example, hovering. According to one embodiment, the space in which the search region is presented can be used to display other elements belonging to the window 100, for example, a metadata display, while the search region is hidden, i.e. when the region 114 has not yet been activated or is no longer activated.

According to some embodiments, user interface elements are categorized into two types for the purposes of determining visibility in relation to user activity. The first type comprises elements that are useful even while the user is not actively engaging the window 100, that is, ‘passive’ elements, such as audio visualizers and metadata displays. The second type comprises elements whose functionalities require active user input, that is, ‘interactive’ elements, such as search-entry elements 114 and playback controls 105. Interactive elements often require targeted user input, for example mouse click on the element, to perform their role in the GUI. According to one embodiment, while the window 100 is not in focus, for example, when the mouse cursor is outside the bounds of window 100, passive elements enjoy display priority over interactive elements. Further, if a passive element and an interactive element occupy the same region while the window is not in focus, the interactive element can be hidden in order to display the passive element. In contrast, according to this embodiment, when the user activates window 100, for example, by moving the mouse cursor within the bounds of the window 100, interactive elements gain priority for display, and can use screen space freed by temporarily hiding any passive elements in the window. According to some embodiments, elements that are hidden due to lower display priority can instead be presented in sharply decreased opacity or clarity, or otherwise altered to be less visually prominent. The preceding approach greatly lowers the screen-space cost required to present all of the varied functionality provided by the window 100.

In the illustrated embodiment, a window 118 for displaying search results is also provided in the GUI 101 as described below. In various embodiments, the window 100 can be associated with an application or a plurality of applications and the user can enter a search criterion to identify one or more records associated with the application(s) which meet the search criteria. For example, the window 118 includes search results 117 which can include one or more search result 119 which meet the search criterion. In accordance with an embodiment where the window is associated with a media application, the user can employ the window 100 to identify records associated with metadata (for example, title, artist, etc.) that meet the search criteria. According to one embodiment, the user enters a text entry of one or more words or phrases in the region 114 where the text entry provides the search criteria.

In FIG. 3, the user has entered “black” as a search criterion. According to one embodiment, the window 118 is automatically rendered in the GUI 101 upon the user's activating a search via the window 100. In a version of this embodiment, the window 118 is located adjacent the window 100 in the GUI 101. In the illustrated embodiment, the window 118 displays one or more search result 119 included in the search results 117, i.e., files that match the search criterion. Accordingly, the search results 117 may include tracks that include the word “black” in the title of the track or in the artist's name or in other metadata.

According to some embodiments, a user can specify one or more tags associated with a particular record such that the record meets search criteria that would otherwise exclude the record from the search results. For example, the user can tag a particular track with a custom tag selected because of the user's association of the track and the tag. According to various embodiments, tagging of a record can be executed from any element in the graphical user interface which presents that record (e.g. search results 119), using traditional interface methods, for example, icon buttons or context menus. According to some embodiments, the searching is performed down to a tag level to allow a user great depth/granularity when performing searches from the small form factor always-on-top window.

According to some embodiments, the window 118 may instead be a panel that is part of window 100. In these embodiments, the search results expand the boundaries of window 100 when they are made visible by search activity, and restore the boundaries of window 100 when they are hidden by the user or from inactivity.

According to a further embodiment, the user can customize the display of the search results 117. For example, the user can specify that the search results 117 can be organized in a particular manner. Where the window 100 is associated with a media player, for example, the organization can be performed alphabetically by track-title, alphabetically by artist and track-title, numerically by playcount, etc. The preceding provide just a few possibilities and the possibilities can vary depending upon the type of application or applications with which the window 100 is associated. Regardless of the application, the options can include any of the metadata accessible via the application.

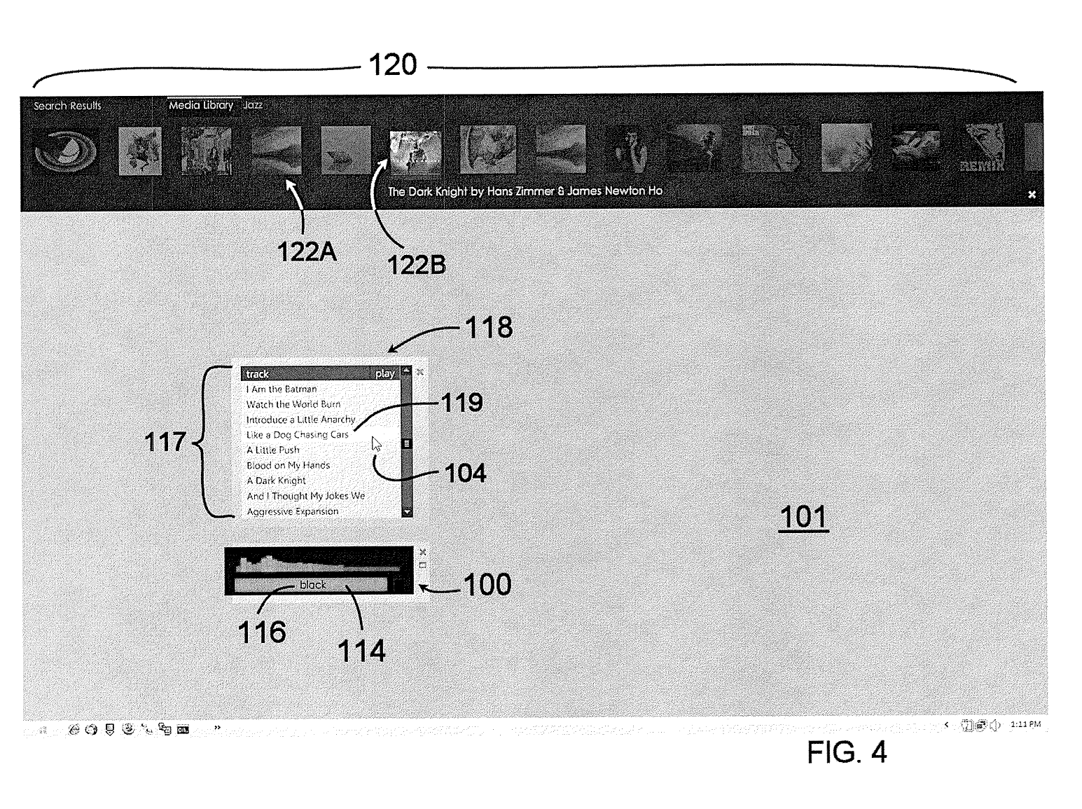

FIG. 4 illustrates an even greater amount of information concerning the search results 117 being provided through user action within the window 118. In a version of this embodiment, that further information is presented within the display 101 when the user activates and/or selects one or more of the search results. In FIG. 4, the GUI 101 includes the window 100, the window 118, and a collection 120 that includes at least one member 122. Further, in the illustrated embodiment, the collection 120 is presented within the GUI 101 in a predetermined region, for example, within a region located at the top of the GUI. According to one embodiment, the predetermined region is an additional window. Further, various elements displayed within the GUI 101 including collection 120 may be displayed at varying degrees of opacity to indicate their temporary status and to allow underlying windows to remain partially visible.

In one embodiment, each member 122 of the collection 120 has an association with at least one search result 119 included in the search results 117. Where the window 100 is associated with a media player, the collection 120 may be a collection of images (e.g., icons) representing distinct albums where each album which is displayed (for example, the members 122A and 122B) includes at least one track which is included in the search results 117.

In one embodiment, the user may locate the cursor 104 over a particular search result in order to highlight and/or display additional information relating to the search result. In FIG. 4, the search results 117 include a search result 119. In the illustrated embodiment, the user has “hovered” the search result 119, a track titled “Like a Dog Chasing Cars”, which is included in the member 122B of the collection 120. Here, the member 122B is highlighted in the region of the GUI in which the collection is rendered. The highlighting can include a change in opacity in the image as well as the display of details of that member of the collection, for example, its title “The Dark Knight.” As illustrated in FIG. 4, other members of the collection (e.g., the member 122A) associated with the search results 117 but not the search result 119 remain displayed without highlighting. According to various embodiments, member 122A and all other members that do not include the hovered search result 119 will be displayed in reduced opacity, clarity, and/or visual prominence. As the preceding illustrates, the user has employed the window 100 to seamlessly and intuitively identify the plurality of search results, a collection and a member of the collection associated with a user-selected search result.

In some embodiments, the collection 120 can include any number of members 122 provided they have some association with one or more of the search results 119. In addition, a single search result may be associated with a plurality of members 122. As a further example, where a search result 119 is hovered and is associated with two or more members 122 of the set of collections 120, each of the members associated with the hovered search result will be highlighted.

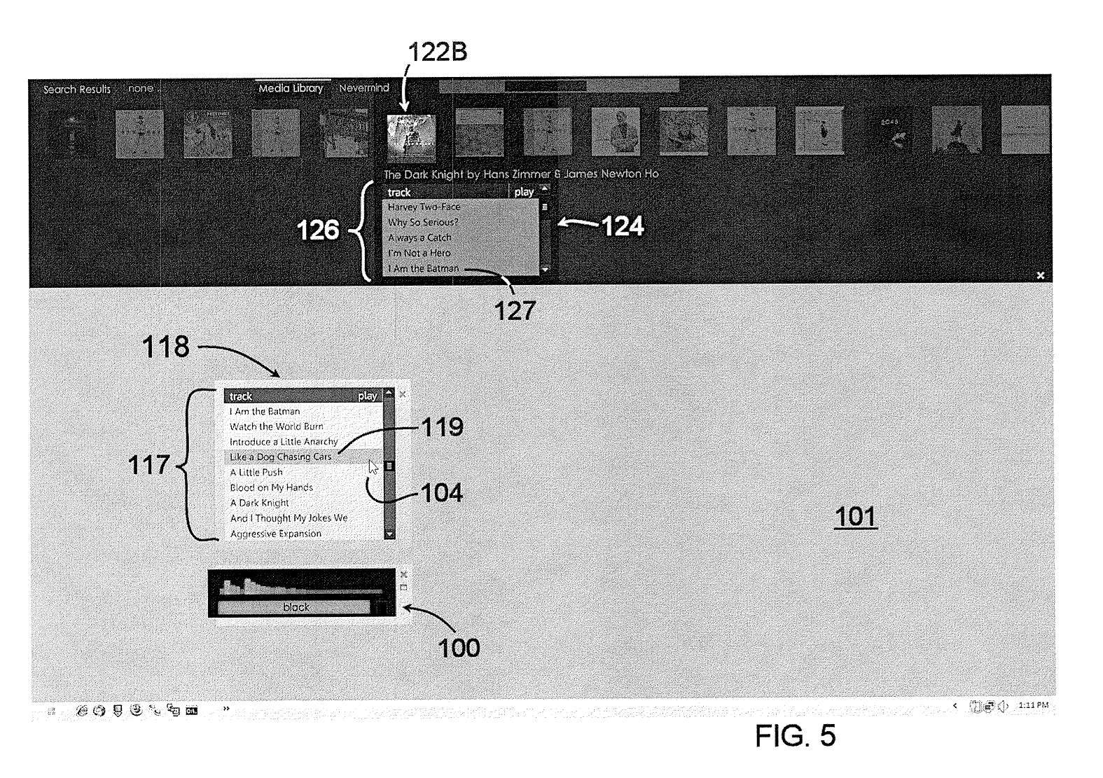

Referring now to FIG. 5, according to some embodiments, further functionality is readily available to the user in an intuitive fashion with a minimal level of user-activity required in the GUI 101. FIG. 5 includes a panel 124 which displays additional information 126, for example, one or more tracks 127 from the member-album 122B. As used herein, the term “panel” is used to describe a region of graphics and/or text rendered in the GUI in a manner which does not itself obscure any underlying application which is also rendered in the GUI. According to one embodiment, a window differs from a panel because the window's boundaries roughly define the area in which underlying applications are obscured, whereas the panel's boundaries define a smaller area, because the panel may be one of many elements including borders and padding rendered in its parent window. Further, according to some embodiments, a panel does not include within it any tools (for example, icon-based tools) that allow the host window to be moved and/or resized. According to one embodiment, a window differs from a panel because a window can be moved or resized by the user and because the window does obscure underlying applications.

In the illustrated embodiment, the user has placed the cursor over the field in which the selected search result 119 is displayed and then selected, (e.g. “clicked”) the field to activate further features, including display of additional information in the panel 124. In one embodiment, the same set of features can be activated in an intuitive manner by selecting the image representation of a collection-member itself. Other approaches to selecting a collection-member in the GUI 101 to generate a display of further information may be provided, including pre-determined keystrokes, control keys and the like. Further, the form of display can vary depending upon the application and/or the type of information which is displayed. FIG. 5 illustrates the display of images, text labels (e.g. album title) and organized lists of related information as some examples. In some embodiments, the preceding approaches may be customized by the user.

In the embodiment illustrated in FIG. 5, the user-action results in additional information 126 being rendered in the GUI 101 in the panel 124: that is, a listing of tracks from the member-album 122B. These tracks may or may not all have been included in the search results; however, they are easily accessible to the user because of a shared relationship with the selected search result 119. In this way, the user can quickly and easily gain access to information concerning a plurality of items which did not meet the search criterion but have an association with at least one item that did meet the search criterion because they all share an association with the member 122B, i.e. they are tracks from the same album. According to various embodiments, whether or not the previously described (or other) shared relationship causes items not included in the search results to be displayed, can be pre-determined as well as toggled by the user through an icon, button, context menu, and/or other interface control method(s). According to further embodiments, when items that did not meet the search criterion are displayed in panel 124, they may be rendered differently from actual search results items, for example having different opacity, outlines, or font decorations, to illustrate this distinction.

According to some embodiments, the GUI components accessible through window 100 provide the user with simultaneous access to top-down control functions, such as showing the track listings included in a collection-member, and bottom-up control functions, such as highlighting a collection-member based on user hovering of an individual search result. In particular, bottom-up control allows the user to organize the entire search results body 117 in a way that might differ from an organization by member-associations among these items, and still be able to quickly examine these member-associations. For example, search results 117 can be sorted alphabetically by track title or by play-count rather than by album.

Providing for bi-directional navigation through the data hierarchy in this manner can be achieved regardless of the data structures associated with the application. For example, if the data source queried by search element 114 is an aggregate database, then search results will be returned as individual items and first presented in window 117, before being assembled along with supplemental data into the groups that constitute the collection 120. On the other hand, if the data source queried is already group-based in structure, search results will be returned on a group-by-group basis to be presented together in collection 120, from which individual search result items can then be aggregated for display in window 117.

Some embodiments allow the user to select and manipulate items from the search results 117 and/or the additional information 126. For example, where the window 100 is employed with a media player, tracks listed in the search results 117 and/or additional information 126 can be added to a playlist. Other types of manipulation can also be provided depending upon the application with which the window 100 is employed.

As illustrated in FIG. 5, a user is able to access a hierarchical arrangement of related information via a window 100 which is sized to avoid a user having to minimize or close the window while other applications are employed and displayed in the GUI 101. According to some embodiments, elements presented in the GUI 101, for example, the collection 120 and the additional information 124, are initially hidden from view, and only appear when user action engages their functionality. In these embodiments, for example, the collection 120 may only appear when the user hovers over a search result in the window 118, and the additional information 124 may only appear when at least one member 122 of the collection 120 has been selected using one of the previously described selection mechanisms. Further, these initially hidden elements will disappear when the user shifts focus in the GUI 101 away from the application associated with window 100. In accordance with some embodiments, this change in visibility occurs following a short delay or ‘grace period’. According to some embodiments, this delay is triggered by the cursor leaving the boundaries of any of the three inter-related elements (e.g., the window 100, the collection 120, and the panel 124), and the delay is reset and its end action canceled if the cursor re-enters the aforementioned boundaries before the delay expires.

In accordance with one embodiment, the window 100 is presented in an always-on-top mode, yet is sized such that it obscures a very small region of the GUI 101. This also results in the window 100 occupying a very small region of a display in which the GUI 101 is rendered. As a result, the user can actively employ other applications in the GUI 101 while maintaining the presence of the window 100. This can be accomplished while all the functionality (for example, full search capabilities) provided via the window 100 remains readily available to the user with a minimum of user effort.

In general, the window 100 is sized to display a clearly discernible set of tools while minimizing an amount of space occupied in the GUI 101 and in the display in which the GUI is rendered. According to one embodiment, the tools and functionality provided via the window 100 are accessible via a simple hovering or “clicking” action. In another embodiment, a pre-established keystroke(s) is employed to activate the tool in the window 100.

In one embodiment, the area occupied by the window 100 is substantially less than 100% of the area of the GUI 101. In a further embodiment, the area of the GUI 101 occupied by the window 100 is substantially less than 20% of the area of the GUI 101. In accordance with a further embodiment, the functionality provided by the window 100 can be presented and accessed with a window which occupies less than 5% of the area of the GUI 101. For example, in one embodiment, the window 100 occupies about 2.64% of the total area of the GUI. In one embodiment where a GUI occupies the full area of a laptop computer with a display having a resolution of 1280×800 pixels, the window 100 occupies an area of 270×100 pixels (i.e., 2.64%). In addition, although the window 100 is illustrated as having a generally rectangular shape, according to some embodiments, the window may be any shape that provides a user with access to information as described herein.

Further, the percentage of the GUI 101 (and the associated display) occupied by the window 100 can be optimized based on the size of display in which the window 100 is employed. For example, in one embodiment, the window can occupy a proportionally smaller area of the GUI (and associated display) and remain clearly discernible when rendered in a relatively large display such as that employed with a desktop computer. Conversely, the window 100 may occupy a proportionally larger portion of the GUI (and associated display) when employed in a relatively small display such as that found in a handheld device. According to another embodiment, the window 100 is sized to occupy no more than a predetermined maximum amount of space where the maximum may be in absolute pixels or determined as a percentage of total area available in the GUI 101. According to this embodiment, a percentage is determined where the resulting size is sufficient to provide the window 100 in a clearly discernible manner in the GUI's host device (e.g. handheld or desktop). Here, the size of the window 100 can be established to minimize the area occupied by the window 100 when in the always-on-top mode while rendering the window 100 in a clearly discernible manner.

Another challenge faced by systems that display information electronically, for example, any computer implemented system that provides a user with a display of metadata associated with files, is the generally fixed manner in which the information is displayed. The display of information included in a list, or for example, a menu, encounters the same difficulty. That is, a display region of a fixed length may be provided for each list-item where the display region includes one or more fields. Often, the area provided for the display of the items in the various fields is insufficient to display the full item.

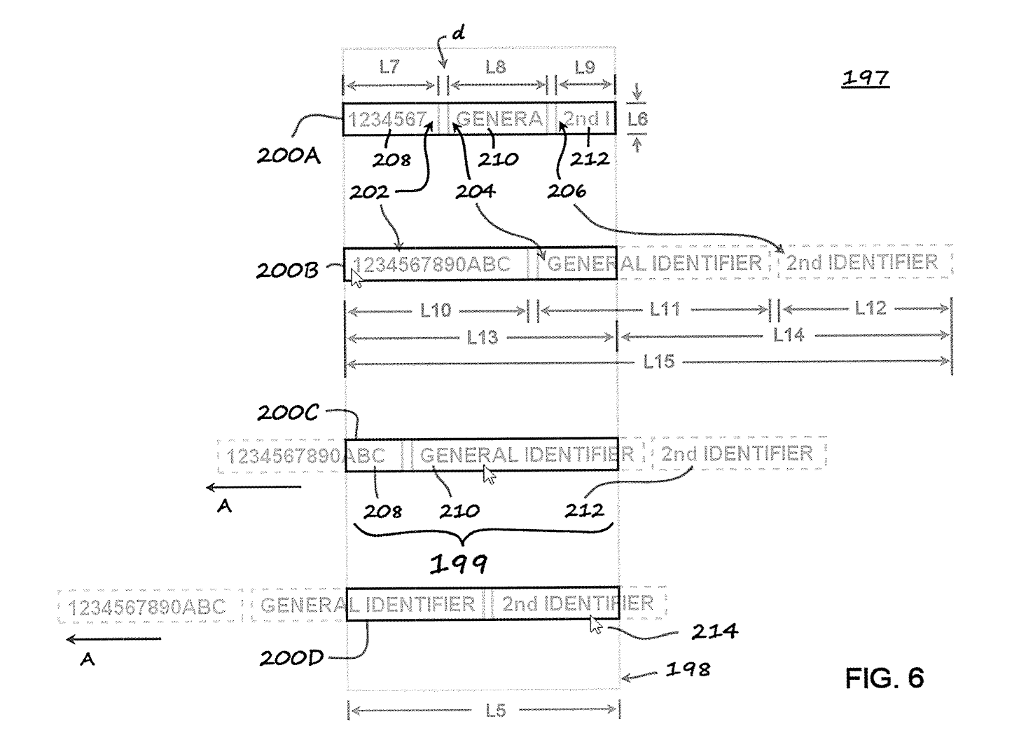

Referring now to FIG. 6, a window 198 including a display region 200 including a length L5 is illustrated where the display region includes a plurality of fields of a record 199. Further, FIG. 6 illustrates four distinct states of the same record, as opposed to four separate records in the same display. The record 199 may include any type of information including alphanumeric or other types of information. According to some embodiments, the window 198 is displayed in a graphical user interface 197. In the illustrated embodiment, the display region 200A includes a first field 202, a second field 204, and a third field 206. Further, the record 199 includes a first item 208, a second item 210 and a third item 212. In some embodiments, the first item 208, the second item 210 and the third item 212 are items of data. In a further embodiment, one or more of the first item 208, the second item 210 and the third item 212 are items of metadata. For example, metadata concerning one or more files such as an audio file to be accessed and played using a device accessed via the graphical user interface 197 in which the window 198 is displayed. In the illustrated embodiment, the first field 202 includes the first item of data 208, the second field 204 includes the second item of data 210, and the third field 206 includes the third item of data 212. Further, the display region 200 may include further fields or fewer fields than those illustrated in FIG. 6, for example, the display region 200 may include only a first field. Alternatively, the display region 200 may include four or more fields.

Referring to the display region 200A, the first field 202 has a first length L7, the second field 204 has a second length L8, and the third field 206 has a third length L9. However, an item's length may exceed the length of the field in which it is enclosed: for example, the first item may have a length L10, the second item 210 may have a length L11 and the third item 212 may have a length L12. Accordingly, the full length L15 of the record 199 includes, the full length L10 of the first item 208, the full length L11 of the second item 210 and the full length L12 of the third item 212. When each item 208, 210, 212 is fully expanded the full record 199 presents all of the information “1234567890ABC,” “GENERAL IDENTIFIER” and “2nd IDENTIFIER.” According to one embodiment, the fields included in a record are initialized with a padding distance d between each adjacent field, where d may be zero, and the fields maintain this distance throughout subsequent expansions and truncations of the fields.

According to one embodiment, the record 199 is displayed in the display region 200 with one or more items 208, 210, 212 truncated to allow the display of at least a portion of each item in the display region 200. This truncation is performed because the fully expanded length L15 of the record is greater than the length L5 of the display region. In accordance with some embodiments, the record is presented in the preceding truncated form where there is no user activity in the region 200.

In accordance with a further embodiment, user activity in the form of the user hovering a cursor 214 over the display region 200 activates the region such that each field is expanded at least to the full length of the item included therein. According to one embodiment, only regions of a record that overlap with the display region 200 will be displayed, even if the fully expanded width of a record exceeds the width L5 of region 200. In the terminology of the field of GUIs, the display region 200 is said to “mask” the various records. Some embodiments respond to further user activity, for example, lateral cursor movement in the display region 200 to scroll across the fully expanded record as a whole and to do so while limiting the visible portion of the fully expanded record to the portion of the record which overlaps the display region 200. That is, the user is able to easily view all of the fully expanded record 119 without needing to expand the display region 200, even though the record's 119 full length L15 is greater than the length L5 of the region.

Display region 200B shows one example where a cursor 214 is employed to activate a record 199 to, in this example, fully expand the record. The expansion results in each item 208, 210, 212 expanding to its full length along with a corresponding expansion of the fields 202, 204, and 206, respectively. Because the length L5 of the record's display region 200B (e.g., the “masking” region) is smaller than the length L15 of the fully expanded record 199, only a portion of the record 199 is visible to the user. Portions of the record 199 outside the masked region are hidden from view. The resulting split between a visible portion of the record 199 and a hidden portion of the record 199 results in a length L13=L5 of the record being displayed (i.e., masked) in the display region 200B and a length L14 (where L14=L15−L13) being hidden. In this example, the first field 208 is fully displayed along with a portion of the second item 210. However, since the fields maintain their adjacent positioning even when expanded, the third item 212 has been pushed to the right of display region's 200 boundaries by expansion of the preceding items (item 208 and item 210), and as a result, is now completely hidden from the user.

In accordance with some embodiments, an activation of the record 199 further allows the user to view the fully expanded record 199 in its entirety by scrolling the record (i.e., shifting the portion of the record that is visible because of masking by region 200). According to various embodiments, this scrolling action can occur either automatically or in response to additional user input. According to one embodiment, a location of the cursor 214 in the display region adjusts an alignment (i.e., lateral location) of the record 199 in the same display region such that the effective visible portion of record 199 is also adjusted. For example, the user has placed (e.g., hovered) the cursor 214 over the display region 200B at the left margin of the display region. As a result, the fully expanded record 199 is left-justified with the left-hand margin of the display region 200B. Throughout the scrolling process, the size of the display region itself remains unchanged and portions of the fields that are not displayed within the display region 200B, shown in phantom, remain hidden to the user until further user action shifts those portions to overlap the display region 200B where they are masked.

For example, a movement of the cursor 214 to the right (while the cursor remains hovered over the display region 200B) results in a leftward shift of the items 208, 210, 212 included in the record 199 as indicated by the arrow A.

As another example, the cursor is approximately centered within a display region 200C, and the fully expanded record 199 is approximately centered in the display region 200C. As a result, the majority of the first item 208 is not displayed despite the fact that the first item 208 is fully expanded. Further, the third item 212 is also fully expanded, however, it also does not appear within the display region 200C because the user activity has not shifted the record sufficiently so that the third item 212 can be displayed in the display region with all items in a fully expanded state. As illustrated by the display region 200D, further cursor movement to the right begins to reveal some of the third item 212 in its fully expanded state within the display region 200D. Right-justification of the cursor within the display region 200 will shift the record further to the left such that the record 199 is right-justified in the region 200D. The display region 200D illustrates one example where the cursor is nearing the right-margin of region 200D. Accordingly, the majority of the third item 212 is displayed in the display region 200D.

In some embodiments, the advantages of the preceding include the ability to work within a fixed display region 200 to easily and intuitively allow a user to read the fully expanded versions of a plurality of items where the combined lengths of the items, when fully expanded, exceeds the length L5 of the display region 200. In accordance with one embodiment, a scroll-rate is determined based on a ratio of the length L15 of the fully expanded record to the length L5 of the display region 200, such that cursor movement from the left margin of the display region 200 to the right margin of the display region 200 moves the record from right to left an amount equal to the length L14.

Further, in some embodiments, the preceding is accomplished with minimal user interaction with a display region or other region within the graphical user interface. That is, in some embodiments the preceding does not require the use of scroll bars or clicking and dragging, but simply requires hovering a cursor above a record selected by the user. In accordance with one embodiment, user activity simply requires that the cursor be placed above the display region 200 and does not require any dwell time before the display bar is fully expanded, that is, the record is automatically fully expanded as soon as the cursor reaches the region of the display where the record is located.

According to various further embodiments, the previously described lateral positioning of a fully-expanded record is a constant activity dependent only on user presence over the record, and does not require, for example, actual lateral movement of the cursor once it is hovering on the record. In these embodiments, for example, if the cursor 104 first entered the bounds of the record 199 through only vertical movement at a horizontal position near the right-margin the display region 200D, the record 199 would both expand and scroll to a position almost right-aligned with the right-margin of region 200D.

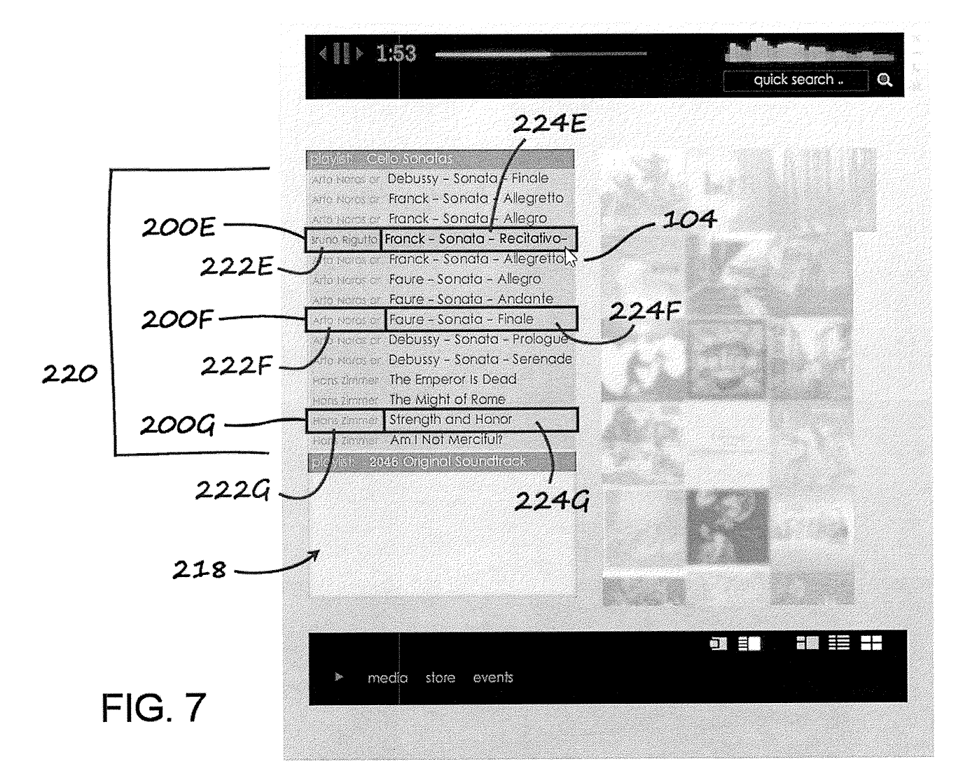

In accordance with some embodiments, the previously described truncation of the items in a record is done in a manner that allows each item to retain maximum chance of being uniquely identified from among similar items of data. For example, referring to FIG. 7, a window 218 includes a plurality of display regions 220 including the display regions 200E, 200F and 200G which include first fields 222E, 222F and 222G and second fields 224E, 224F and 224G, respectively. There is no user activity in each of the display regions 200F and 200G. Accordingly, the items located in the fields 222F, 222G, 224F and 224G are truncated because the record is not fully expanded. For each of the items located in the fields 222F, 222G, 224F and 224G, portions of the item at a position greater than the truncated width of the field in which the item is displayed are hidden. In accordance with some embodiments, the preceding approach provides the advantage of truncating each item so that the portion of the item that is displayed is a portion where a user would normally begin when reading the item. That is, in most European and other languages in which reading begins from the left, accordingly, the items displayed in the display region each begin at the left and are truncated only at the right, if necessary.

According to further embodiments, the truncated lengths are also determined such that when all truncated items are positioned adjacent each other, the sum of their lengths equals the length of the display region 200, ensuring that all truncated items are visible (i.e. when a record is in truncated form, all of its items fall completely within the boundaries of the record's masked-region).

The cursor 104 is located near the right margin of the display region 200E. As a result, the record associated with the display region 200E is fully expanded and the items displayed in the fields 222E and 224E are nearly right justified. This is apparent when the contents of the field 222E are compared with the contents of the field 222F. When fully expanded, each item provides artists' names, for example, “Arto Noras and Bruno Rigutto” which is too large to display in the field. Accordingly, a truncated version of the artists' names is displayed in the inactive fields 222G and 222F while an expanded and nearly fully right justified item is displayed in the field 222E. In accordance with previously described embodiments, the track-title displayed in the field 224E is also fully expanded. As shown here, the user has seamlessly discovered the full title of field 224E without needing to expand the boundaries enclosing display region 200. Further, even though the other records have been truncated to allow simultaneous partial presentation of artist and track-title fields for each record, this truncation has not impacted a user's ability to distinguish the tracks by Arto Noras and Bruno Rigutto from those by Hans Zimmer (see field 222G).

According to some embodiments, the scrolling feature can be used to shift items collectively such that each of the artist names in the fields 222E, 222G and 222F and each of the track titles in the fields 224E, 224F and 224G can be scrolled together based on user activity in any one of the fields. For example, locating the cursor 104 on the right of any of the preceding fields will result in a right justification of each of the records against the right margin of display region 220. The preceding embodiment may be particularly advantageous when a known portion of data is shared among more than one record in the window 218, and so may be quickly surveyed or screened by the user. For example, a file extension or other prefix or suffix-type information having a consistent position within the data item may provide such a portion.

According to further embodiments, expansion of a record and the subsequent scrolling of that record within a particular display region are reversed when the record is no longer the subject of a user's focus (e.g. when the mouse cursor leaves the boundaries of the record's visible portion). That is, following such a change in focus, each item in the record reverts to its truncated state, and the record returns to a lateral position such that all of the items in their truncated forms are again visible within the display region. One advantage of the above embodiment over prior approaches is that the user does not need to re-adjust the enclosing display region to a compact size after having expanded the region, since the display region was never expanded in the first place.

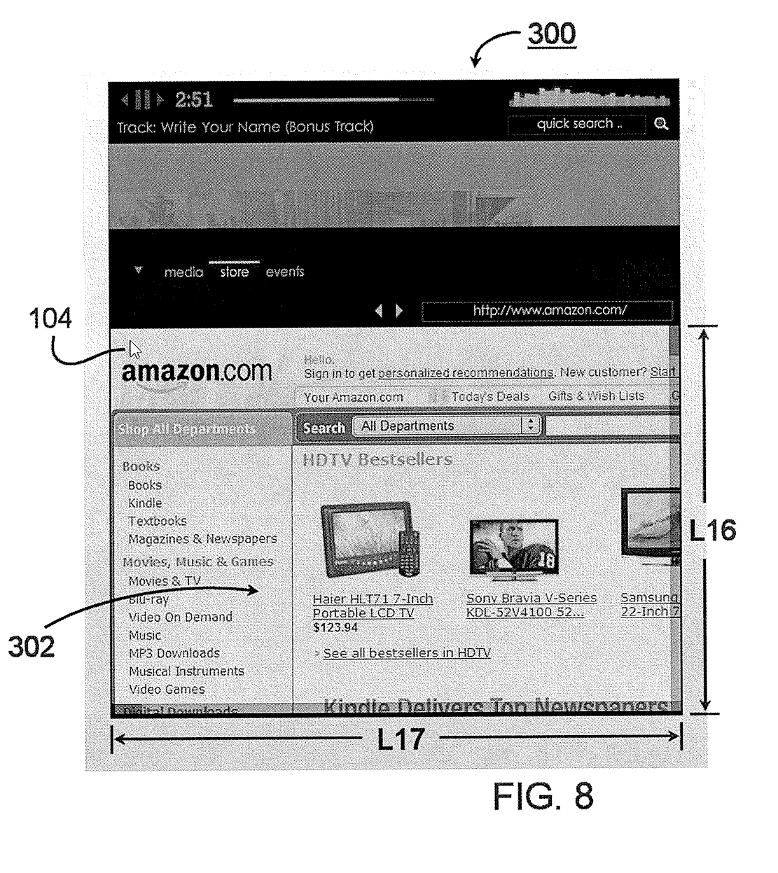

Referring now to FIG. 8, according to some embodiments, a scrolling feature is employed at a document and/or page level. FIG. 8 illustrates a window 302 rendered in a GUI 300. An area of the window 302 is defined by the dimensions L16 and L17, the height and the width, respectively. In accordance with one embodiment, the window 302 can be accessed via user activity in the window 100 previously described with reference to FIGS. 1-5.

The window 302 includes a region of a web page that is displayed therein. A movement of a cursor 104 within the window 302 allows a user to scroll the contents of the web page within the region of the display. That is, the displayed contents of the web page are tied to the cursor location within the window 302. Accordingly, locating the cursor 104 in the upper left-hand corner of the window 302 results in the web page being top-left justified in the window 302. Similarly, a right-hand movement of the cursor 104 in the window 302 moves the contents of the web page to the left and downward movement of the cursor moves the contents of the web page upward in the window. The preceding approach can be employed with any content displayed in the window 302. In some embodiments, the approach is employed with documents which are rendered in the window 302. Accordingly, some embodiments allow a user to adjust the view of a selected content based on movement of a cursor hovered above the window in which the content is displayed. It should be apparent how the preceding provides a more intuitive and efficient “document-level scrolling,” for example, because it does not require the use of scroll bars. Further, the approach may be particularly advantageous when used with PDAs, cell phones or other devices that include relatively small screen sizes that limit the area of a web page that can be displayed at any one time within a display.

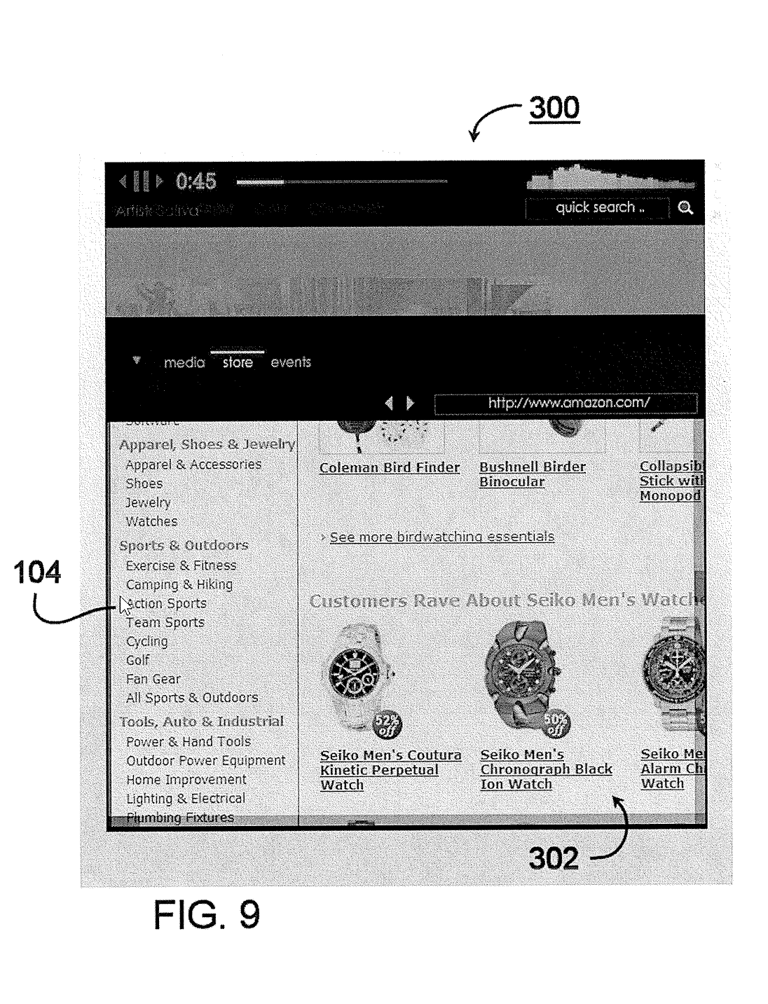

FIG. 9 provides a further example. Here, the user has scrolled down the document by moving the cursor downward along the left margin of the display window. According to one embodiment, the scroll rate is based on the size of the window 302 relative to the size of the displayed document or web page at the current magnification of the document or web page being viewed. Because the scroll rate is based on relative sizes, a user can scroll to the mid point of the left-hand margin of the page by moving the cursor downward to the midpoint on the left margin of the window 302.

As can be seen by the preceding, the approach provided in some embodiments allows a user to intuitively and quickly navigate around a web page or, for example, a page (or pages) of a document. That is, in a further embodiment the preceding approach can be used to move a page of a document, for example, a PDF document across a display window and to do so using a cursor movement. In accordance with one embodiment, the document-level scrolling described herein becomes available when a user activates it by a modifier key provided in a key pad, for example, when a user selects the “control key” to activate a document level scrolling mode. In a version of this embodiment, the document level scrolling mode is deactivated when the user releases or deselects the modified key.

According to some embodiments, the preceding approaches allow a user to scroll in any of 360° within the window 302 and to do so without having to select and move scroll bars. Further, according to some embodiments, the document-level scrolling mode allows a user to scroll a one page document as quickly as a five page document because the system provides for a relative scrolling speed adjustment that allows a user to scroll a document from top to bottom with the same cursor movement regardless of the size of the document. That is, in one embodiment, the cursor movement used for scrolling has a maximum range defined by the dimensions L16 and L17 of the window 302. As a result, any size document (including a multi-page document) can be scanned from top to bottom by moving the cursor a distance defined by L16.

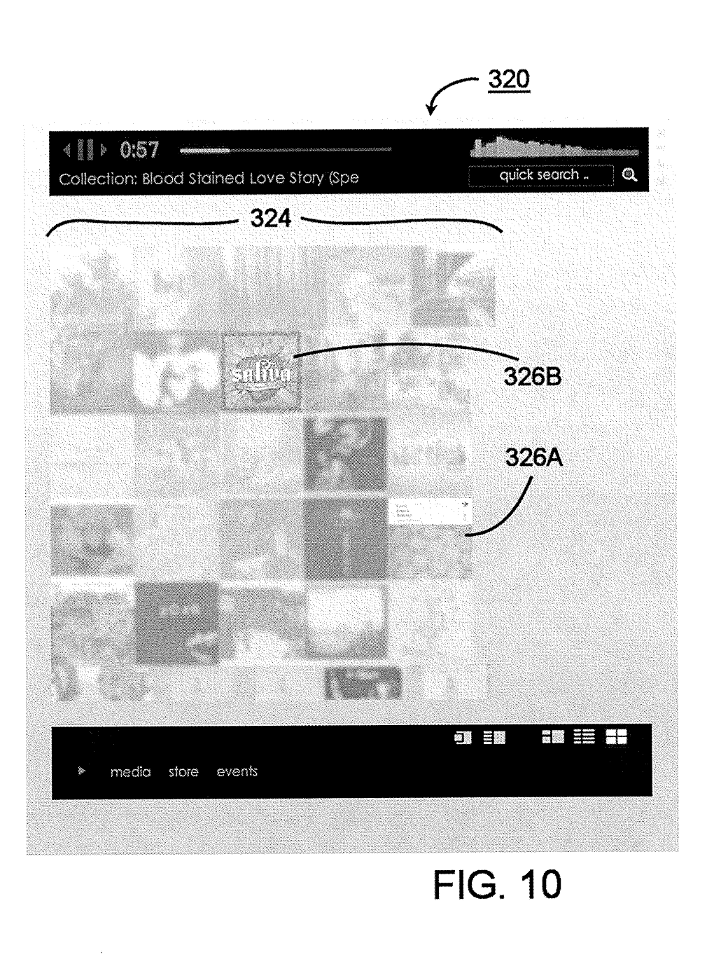

Referring now to FIG. 10, a GUI 320 is illustrated in accordance with one embodiment. In various embodiments, the GUI 320 is rendered in a display. A collection of images (e.g., icons) 324 is provided within the graphical user interface 320. The collection 324 includes a plurality of members 326. In the illustrated embodiment, each member is an icon which represents an album containing one or more tracks. For example, the collection of albums might be those that are stored in local memory on a user device such as a computer, cell phone, or PDA. In some embodiments, the GUI 320 can be accessed via the small form factor window 100 described with reference to FIGS. 1-5.

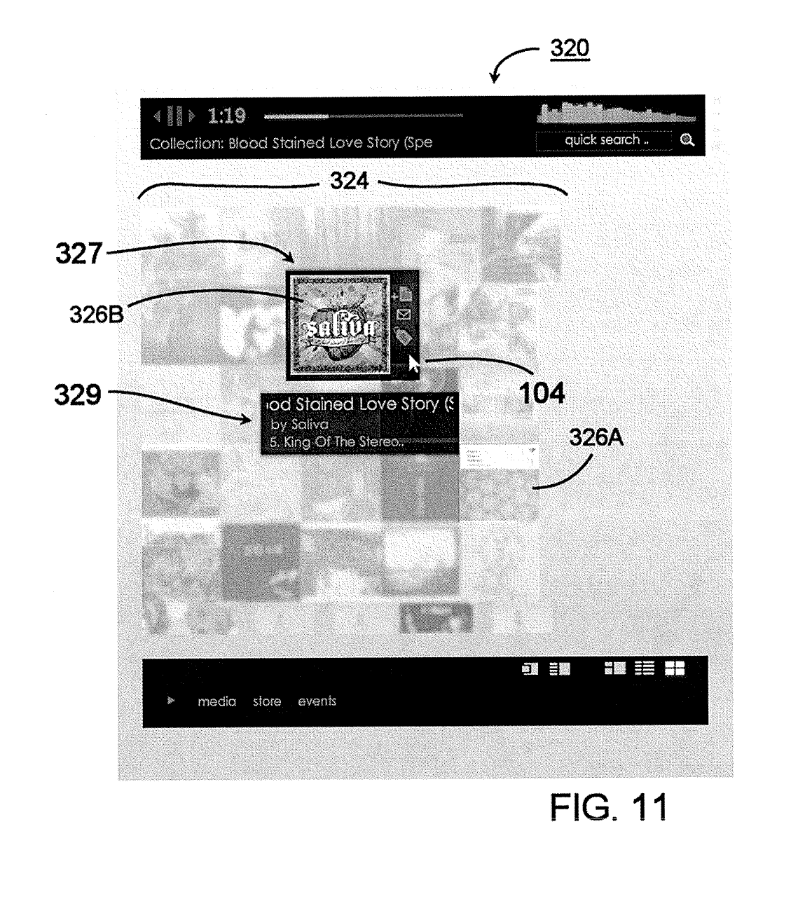

In accordance with the embodiment illustrated in FIG. 11, the member 326B included in the collection 324 is engaged in order to provide details concerning the collection. In accordance with one embodiment, the user engages a member 326 by hovering the cursor 104 over that member. Control elements (including icon-based control elements) may be presented within the panel 327. For example, control elements can provide for: the emailing or sending of the member 326 or information associated with the member, for example, a selected track; manipulation of metadata associated with the member 326B or its constituents, for example, customized tagging; and the addition of the member or associated information to a list or other form of data organization, for example, the user may add one or more tracks included in the member 326B to a playlist. In accordance with one embodiment, additional information related to the member 326B is displayed in a window 329 adjacent the panel 327 when the user hovers over the member 326B.

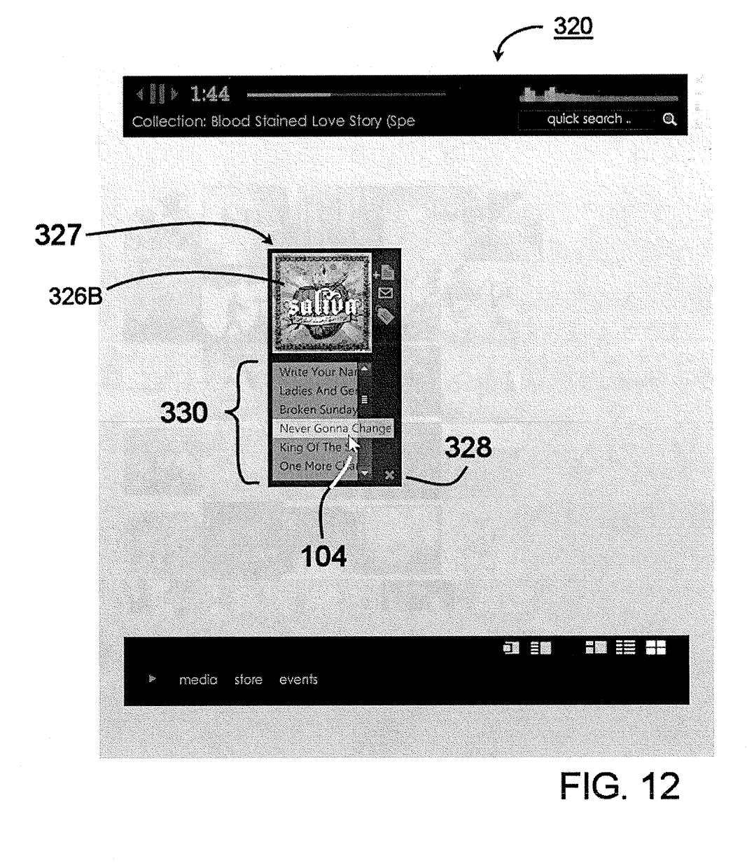

Referring FIG. 12, further details concerning the member 326B are displayed when the user “clicks-on” (or otherwise takes action in) the member 326B. According to one embodiment, the panel 327 expands in size provide space for these additional details. In the illustrated embodiment, the additional details include a list of tracks 330 which are included in the selected member. Activity in the area of the list 330 allows the user to review more information and execute functions that are relevant to each of the tracks. For example, the user can hover the cursor 104 over a track to render a tooltip with the full track name in the panel 327. The user can also select a track for immediate playback or addition to a playback queue. According to another embodiment, the list of tracks 330 is rendered in a window that is separate from but adjacent to the panel 327 which includes the image of the selected member 326B.

According to one embodiment, when the member 326B is selected, other members of the collection 324 no longer respond to user activity, for example, the movement of the cursor over the region of the unselected member 326A. In this embodiment, the visual representation of the other members may decrease in opacity, clarity, or otherwise change to indicate their unresponsive status.

In further embodiments, a selection of the member 326B causes an additional control element 328 to be presented in the panel 327. Selecting this element 328 will return member 326B to an inactive state, at the same time hiding the panel 327 and its control elements, hiding the details 330, and making the other members responsive again. The actions associated with selecting element 328 can alternately be invoked through other means, for example, keyboard shortcuts or clicking on the background of panel 327.

In general, the embodiments described herein can be employed in a wide variety of applications. Thus, although various embodiments described herein include details concerning a media application some embodiments are employed in other types of applications and with other types of data and information. In general, the methods and systems described herein provide an intuitive graphical access to data that can be organized into collections of members that share at least one common thread. In medical applications, for example, a search may be conducted from the small form factor always-on-top window to identify and display a patient list where patient photos are members displayed as a collection. According to this embodiment, activation of a member (i.e., a patient photo) can generate the display of additional information such as a chronological list of the patient's office visits. In another embodiment, the search results provide a list of stock trades in some database, and the collection rendered in the GUI includes members that display a chart concerning the recent share price of a stock included in the search result. In this embodiment, the selection of a member can provide additional details concerning the stock such as the user's recent trades involving the stock. Embodiments may also be employed in the field of research where a collection can provide as members bar graphs of the results of a number of trials conducted with a drug. In this embodiment, the selection of a particular bar graph can result in the display of additional details concerning that trial such as outcomes at specific points in time.

According to various embodiments, the data accessed via the window 100 is data stored in a local memory. According to other embodiments, the data is retrieved from a remote device on which it is stored. For example, the data may be retrieved over a network which may include any of wide area network (such as the Internet), a local area network or any combination of the preceding. The network connection may be a hardwired connection, a wireless connection or may employ both wired and wireless networks that connect the computing device with which the GUI (including the window 100) is employed to a source of data. For example, the computing device may receive information from a remote server. Further, embodiments may be employed with database management systems such as those provided by, for example, Oracle database management systems. According to these embodiments, the window 100 can be employed as described herein to provide an intuitive and readily available tool to access data stored in or indexed by the database(s).

Any of the above-described embodiments, may be included in a computer system or computing device including a display. Such a computer system generally also include a processor connected to one or more memory devices, such as a disk drive memory, a RAM memory, Flash memory, EEPROM, SRAM or other device for storing data. The memory is typically used for storing programs and data during operation of the computer system. Software, including programming code that implements embodiments of the present invention for rendering on the display, is generally stored on a computer readable and/or writeable nonvolatile recording medium and then copied into memory wherein it is then executed by the processor. Such programming code may be written in any of a plurality of programming languages, for example, Java, Javascript, Actionscript, Visual Basic, C, C+, or C++, Fortran, Pascal, Eiffel, Basic, COBOL, or any of a variety of combinations thereof. In some embodiments, the computer readable medium includes memory which is used to store the program and/or data. For example, in one embodiment, the computer readable medium can include memory which is used to store the program and/or data on a temporary basis.

One or more portions of such a computer system may be distributed across one or more computer systems coupled to a communication network. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). The elements of such embodiments may be embodied in software, hardware, firmware, a combination of two or more the preceding, or a combination of any of the preceding and additional elements.

Although the term “window” is used herein to describe an interface rendered in a GUI, the term “window” is not employed to describe or imply any specific functionality. Instead, the functionality provided by the window(s) is described herein with reference to the above-described embodiments. In some embodiments, each of a window and a panel can provide an interface in the GUI.

Further, any of the embodiments described herein can be employed with a computing device, for example, a handheld computing device that employs a touch screen in which the graphical user interface is rendered. In accordance with some of these embodiments, a cursor is not employed and the user initiates actions for one or more applications by touching (using a finger, a wand, etc.) regions of a display corresponding to a location of selected elements of an interface which is rendered in the display.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of providing search capabilities for searching a plurality of audio files via a graphical user interface presented in a display, the method comprising acts of:
presenting, in the graphical user interface, a window to provide information concerning at least one of the plurality of audio files;
configuring the window to operate in an always-on-top mode within the display, and while in the always-on-top mode, the window occupying an area that is substantially less than 100% of an overall area provided by the display;
providing a search entry element in the window when the window is configured in the always-on-top mode, wherein the search entry element is configured to receive at least one search criterion provided by a user, the search criterion established by the user to identify at least one audio file from among the plurality of audio files; and
providing at least one additional interface in the graphical user interface, the at least one additional interface configured to present at least one of search results and information having an association with a search result included in the search results, wherein the at least one additional interface is configured to be initialized as hidden and then displayed when the user performs at least one of initiating a search and actively engaging either of the search results and the information having the association with the search result.

2. The method of claim 1, further comprising an act of presenting at least one control element in the window.

3. The method of claim 2, wherein the act of presenting the at least one control element includes an act of presenting a playback control element in the window.

4. The method of claim 1, further comprising an act of receiving a text element as the search criterion.

5. The method of claim 1, wherein the act of configuring the window to operate in the always-on-top mode further comprises an act of configuring the window to occupy an area that is less than about 20% of an overall area provided by the display.

6. The method of claim 1, wherein the act of configuring the window to operate in the always-on-top mode further comprises an act of configuring the window to occupy an area that is less than about 5% of an overall area provided by the display.

7. The method of claim 1, further comprising an act of determining which of the plurality of audio files meet the search criterion based on metadata which is associated with each of the plurality of audio files, respectively.

8. The method of claim 1, further comprising an act of displaying the search results in a second window within the display adjacent the first window.

9. The method of claim 8, further comprising an act of automatically presenting an audio collection including an image of at least one member of the collection in a third window in the display, wherein each of the at least one member of the audio collection includes an association with at least one search result.

10. The method of claim 9, further comprising an act of highlighting an image of a member of the audio collection in the third window in response to the user hovering over a search result presented in the second window, the search result presented in the second window being associated with the member identified by the highlighted image.

11. The method of claim 10, further comprising an act of presenting in the third window a list of audio tracks from the member of the audio collection in response to the user selecting the search result presented in the second window.

12. The method of claim 11, wherein an audio track from the member of the audio collection is included in the list of audio tracks even if the audio track itself does not meet the search criterion provided by the user and so was not included in the search results.

13. The method of claim 10, wherein the act of highlighting the image of the member includes an act of adjusting at least one of an opacity of the image, a dimension of the image, a position of the image within the display, and an intensity of at least one color in the image.

14. The method of claim 10, wherein the act of highlighting the image of the member includes an act of presenting in the display a label associated with the member of the audio collection.

15. A method of providing search capabilities in a graphical user interface employed with a computing device, the method comprising acts of:
presenting, in the graphical user interface, a window configured in an always-on-top mode, the window occupying an area that is substantially less than 5% of an overall area provided by the graphical user interface; and
providing a search entry element in the window when the window is configured in the always-on-top mode and without changing the area occupied by the window, wherein the search entry element is configured to receive at least one search criterion provided by a user, the search criterion established by the user to identify at least one record from among a plurality of records associated with an application.

16. The method of claim 15, wherein the record includes information concerning a subject, wherein the method further comprises an act of displaying search results including a plurality of records concerning a plurality of subjects, respectively, within a window adjacent the window which is configured in the always-on-top mode.

17. The method of claim 16 further comprising an act of automatically presenting a collection of images concerning the plurality of subjects in the graphical user interface.

18. The method of claim 17, further comprising an act of providing additional information in response to the user hovering over a record included in the search results, the additional information presented in a panel adjacent an image of a member included in the collection of images where the member is associated with a plurality of subjects including the subject with which the record is associated.

19. The method of claim 15, further comprising an act of providing at least one additional interface in the graphical user interface, the at least one additional interface configured to present at least one of search results and information having an association with a search result included in the search results, wherein the at least one additional interface is configured to be initialized as hidden and displayed when the user performs at least one of initiating a search and actively engaging either of the search results and the information having the association with the search result.

20. A method of displaying a record in a graphical user interface rendered in a display, the method comprising acts of:
providing a display region having a region length, the display region configured to display at least one field of a record, the record having a full length greater than the region length;
configuring the record such that successive fields in the record are initialized horizontally adjacent to each other;
configuring the display region such that the at least one field is only visible in the display region for portions of the at least one field which overlap the display region; and
configuring the graphical user interface to allow all portions of the record to be viewed within the display region by movement of the record relative to the display region.

21. The method of claim 20, further comprising an act of truncating, when there is no user activity in the display region, each of the at least one field to a truncated length, respectively, wherein the truncated length of each the at least one field is constrained to a maximum length which is a proportional percentage of the region length.

22. The method of claim 21, further comprising an act of determining the truncated length of each of the at least one field, respectively, such that a sum of truncated lengths of all fields in the record approximately equals the region length.

23. The method of claim 21, further comprising an act of determining the truncated length of each of the at least one field, respectively, based on a relative importance of data included in the at least one field in at least one of identifying the record and using the record.

24. The method of claim 20, further comprising an act of expanding each field of the record to accommodate a full length of an item displayed in each field, respectively, in response to at least one of a user activity in the display region and a user presence in the display region, by expanding a length of each field to accommodate the full length of the item displayed in each field without adjusting the region length while maintaining the successive fields in horizontally adjacent positions.

25. The method of claim 20, further comprising an act of moving, based on a cursor position within the display region and in response to at least one of a user activity in the display region and a user presence in the display region, the record to allow viewing of a full length of the record, the full length provided by a combined length of all fields included in the at least one field of the record.

26. A computer-readable medium encoded with instructions for execution on a computer system, the instructions when executed, performing a method comprising acts of:
presenting, in a graphical user interface, a window to provide information concerning at least one of a plurality of audio files;
configuring the window to operate in an always-on-top mode within the display, and while in the always-on-top mode, the window occupying an area that is substantially less than 100% of an overall area provided by the display;
providing a search entry element in the window when the window is configured in the always-on-top mode, wherein the search entry element is configured to receive at least one search criterion provided by a user, the search criterion established by the user to identify at least one audio file from among the plurality of audio files; and
providing at least one additional interface in the graphical user interface, the at least one additional interface configured to present at least one of search results and information having an association with a search result included in the search results, wherein the at least one additional interface is configured to be initialized as hidden and then displayed when the user performs at least one of initiating a search and actively engaging either of the search results and the information having the association with the search result.
